(19) United States
(12) Patent Application Publication
(10) Pub. No.: US 2019/0070441 A1
(43) Pub. Date: Mar. 7, 2019

(54) COMPACT AIR FILTER MASK

(71) Applicants: ARTIN ARCHOUNIANI, Tehran (IR); AREG AZIZIANS, Tehran (IR)

(72) Inventors: ARTIN ARCHOUNIANI, Tehran (IR); AREG AZIZIANS, Tehran (IR)

(21) Appl. No.: 16/178,109

(22) Filed: Nov. 1, 2018

Related U.S. Application Data
(60) Provisional application No. 62/677,883, filed on May 30, 2018.

(51) Int. Cl. A62B 23/06

(52) U.S. Cl. CPC A62B 23/06

(57) ABSTRACT

The various embodiments herein provide a compact air filter mask with adjustable size comprising a nostril unit and a filter unit. The nostril unit comprises a nostril cap and an air pipe. The nostril unit holds the air filter mask tightly inside a nostril of a wearer. The filter unit comprises an upper cap, a filter and a lower base. The nostril unit is fixed removably in the filter unit.

### BACKGROUND

### Technical Field of Invention

The embodiments herein generally relate to a medical device and particularly relate to an air filter mask wore over nostrils of a user. The embodiments herein more particularly relate to an air filter mask having usage during various activities as well as various situations such as during a high mist situation as well as during flu outbreak.

### Description of Related Art

A dust mask is a flexible pad held over the nose and mouth by elastic or rubber straps to protect against dusts encountered during construction or cleaning activities, such as dusts from drywall, brick, wood, fiberglass, silica (from ceramic or glass production), or sweeping. A dust mask can also be worn to protect against allergens.

To enhance a user implementation of the dust mask, several prior art devices are developed. One of such prior arts discloses a compact multipurpose dustproof mask includes a body pipe having an outlet hole formed at one end and a mouth contact hole formed at the other end thereof, and the end where the mouth contact hole is formed is held in the mouth and/or nose, a backward flow preventing ball installed to be capable of moving back and forth and pressed by a returning means in a direction to block a narrow hole formed inside the body pipe so that the body pipe can be open/shut according to pressure of internal air, and a branch pipe formed between the mouth contact hole of the body pipe and the backward flow preventing ball, the branch pipe having an inlet hole having a shape corresponding to a filter formed at one end thereof so that the filter is connected.

Another prior art discloses a dustproof mask comprises a filter unit disposed inside a mask cover. The filter unit is provided with a baggy filter having an inhalation hole in a position corresponding to a mouth of a user. A boundary plate disposed adjacent the filter unit has vent holes opposing the inhalation hole. The user can only take in clean open air through the filter when the user inhales open air through the mouth and the user can only exhale inner air through the nostrils.

However, the prior art masks are limited in optimal filtration of air as they fail to cover entire area on the users' face, hence a gap between the face and the mask lets the polluted air in. Further, due to coverage of large area of nose, face and mouth by the prior art masks, it becomes difficult to speak, eat or drink freely by the user. Further, majority of prior art masks become unusable after few usages as they cannot be cleansed effectively.

In the view of foregoing, there is a need for a compact air filter mask that covers least area of a face but filters an air entering the nostrils optimally. Also, there is a need for an air filter mask with multiple degree of movement to ease a usage of the mask during various activities. Also, there is a need for a mask having a cleanse-able and removable filter.

### SUMMARY OF THE INVENTION

The primary objective of the embodiments is to provide a compact air filter mask that covers least area of a face but filters the air entering the nostrils optimally.

Another objective of the embodiments herein is to provide an air filter mask with multiple degree of movement to ease a usage of the mask during various activities.

Yet another objective of the embodiments herein is to provide a mask having a cleanse-able and removable filter.

The various embodiments herein provide a compact air filter mask with adjustable size comprising a nostril unit and a filter unit. The nostril unit comprises a nostril cap and an air pipe. The nostril unit holds the air filter mask tightly inside a nostril of a wearer. The filter unit comprises an upper cap, a filter and a lower base. The nostril unit is fixed removably in the filter unit.

According to one embodiment herein, the nostril cap is fitted in the air pipe through a plug-in locking mechanism.

According to one embodiment herein, the nostril cap is made up of an elastomeric material.

According to one embodiment herein, the filter is fitted in a housing formed by plugging the upper cap in the lower base. A lower part of the air pipe is fitted removably in the nostril cap.

According to one embodiment herein, the lower part of the air pipe is a shape of a ball and fits into a socket of the upper cap forming a ball and socket joint. The ball and socket joint allows the filter unit to move in a plurality of directions.

According to one embodiment herein, the filter has a layer of a net and is attached to an elastomeric layer from sideways to prevent a flow of air from corners of the filter unit.

According to one embodiment herein, the filter has an area of 210 sq. mm. to provide high resistance to an air flow during inhaling and exhaling.

According to one embodiment herein, a movement of an air pipe of a left nostril is independent of a movement of the air pipe of a right nostril to provide a movement in a same as well as different directions.

According to one embodiment herein, the filter is chosen from an air filter as well as anti-bacterial filter.

These and other aspects of the embodiments herein will be better appreciated and understood when considered in conjunction with the following description and the accompanied drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIG. 1a-1d illustrates a front view, a top view, a bottom view and a side view respectively of an air filter mask, according to one embodiment herein.

FIG. 2a-2b illustrates an exploded view of the air filter mask, according to one embodiment herein.

FIGS. 3a and 3b illustrates an exploded view of a filter and a protective unit respectively of the air filter mask, according to one embodiment herein.

FIG. 4a-4c illustrates a front view, a top view and a side view of the air filter mask with a filter area and various degrees of movement, according to one embodiment herein.

FIG. 5a-5b illustrates a ball and socket joint in a nostril inlet for enabling various degrees of movement, according to one embodiment herein.

FIG. 6a-6d illustrates a front view, a top view, a bottom view and a side view of the air filter mask with dimensions, according to one embodiment herein.

FIGS. 7a and 7b illustrates a fixation of the air filter mask in a user's nostrils and an air filtration by the air filter mask during usage, according to one embodiment herein.

### DETAILED DESCRIPTION OF THE DRAWINGS

In the following detailed description, a reference is made to the accompanied drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

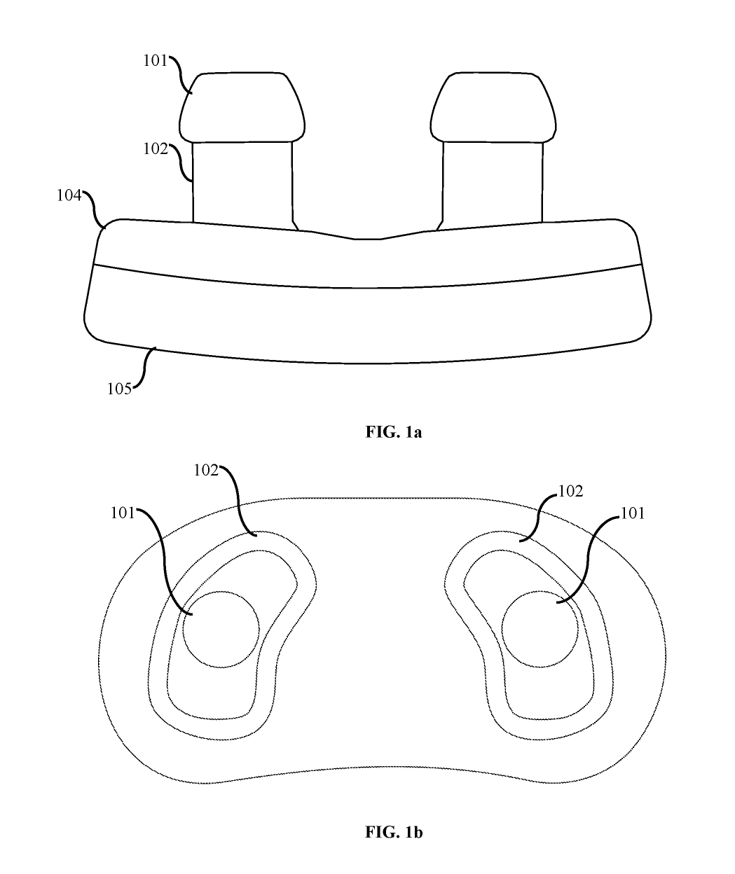

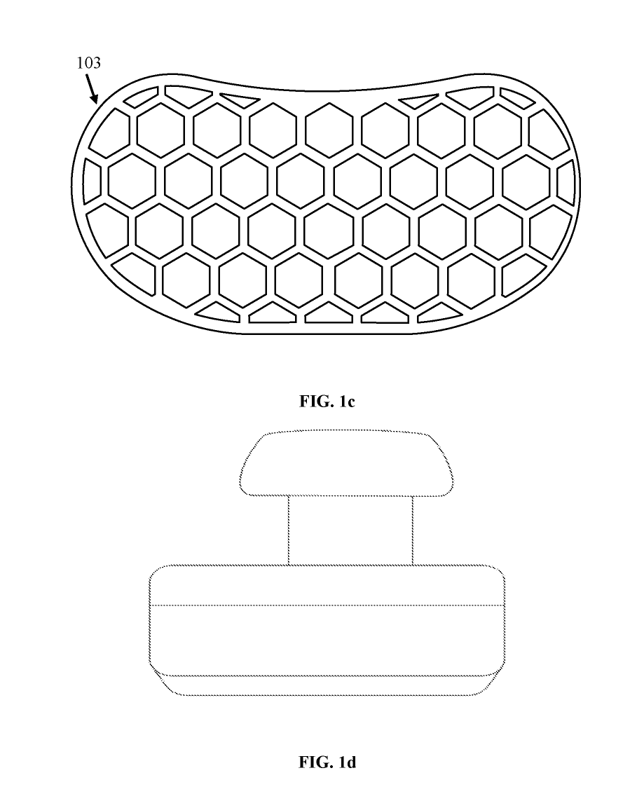

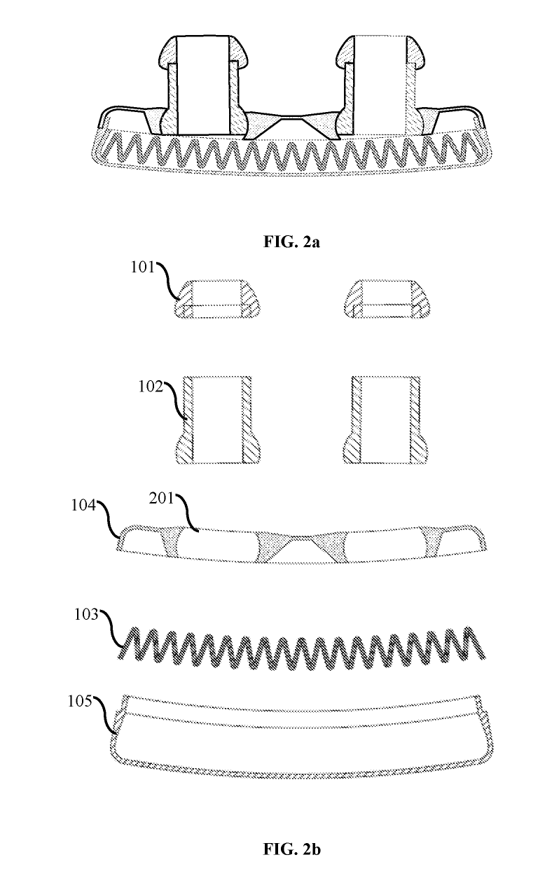

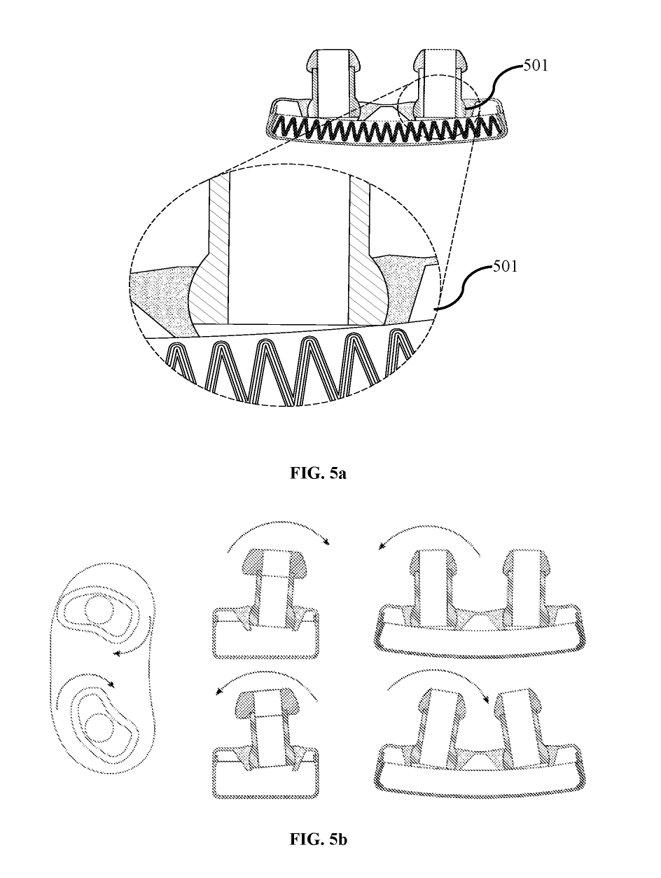

FIG. 1a-1d illustrates a front view, a top view, a bottom view and a side view respectively of an air filter mask, according to one embodiment herein. With respect to FIG. 1a-1d, a compact air filter mask with adjustable size comprising a nostril unit and a filter unit. The nostril unit comprises a nostril cap 101 and an air pipe 102. The nostril unit holds the air filter mask tightly inside a nostril of a wearer. The filter unit comprises an upper cap 104, a filter 103 and a lower base 105. The nostril cap 101 is fitted in the air pipe 102 through a plug-in locking mechanism. The lower part of the air pipe 102 has a shape of a ball and fits into a socket 201 provided in the upper cap 104 forming a ball and socket joint (as shown in FIGS. 2a and 2b). The lower base 105 is also removably locked slots provided in the upper cap. The ball-and-socket joint allows the filter unit to move in a plurality of directions, primarily in lateral directions (As shown in FIGS. 5a and 5b). Further, the filter 103 is fitted in a housing formed by plugging the upper cap in the lower base.

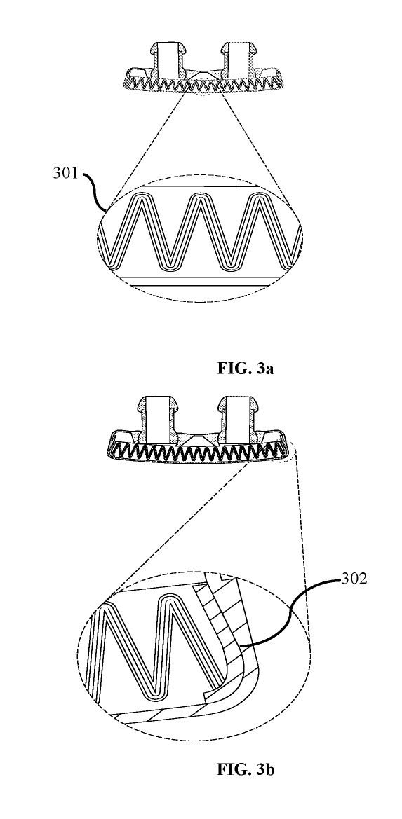

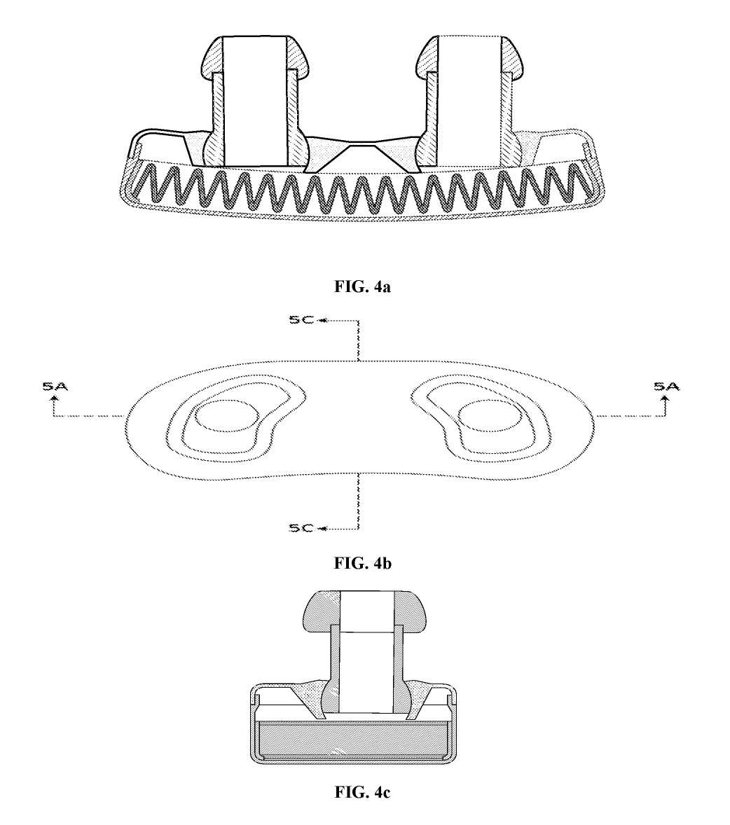

As shown in FIGS. 3a and 3b, the filter 103 has a layer of a net 301 for protection from distortion of a shape and is attached to an elastomeric layer 302 from sideways to prevent a flow of air from corners of the filter unit. The elastomeric layer forms an air tight chamber so that the air flows only through the filter and not from sides thus preventing a dust and pollution to enter in nostrils.

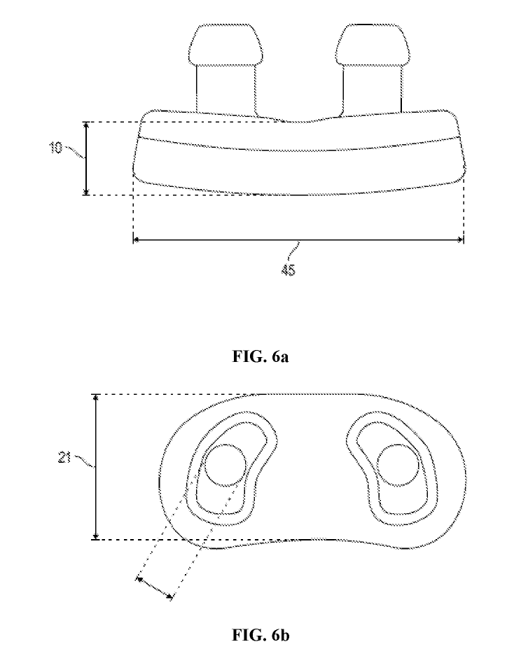

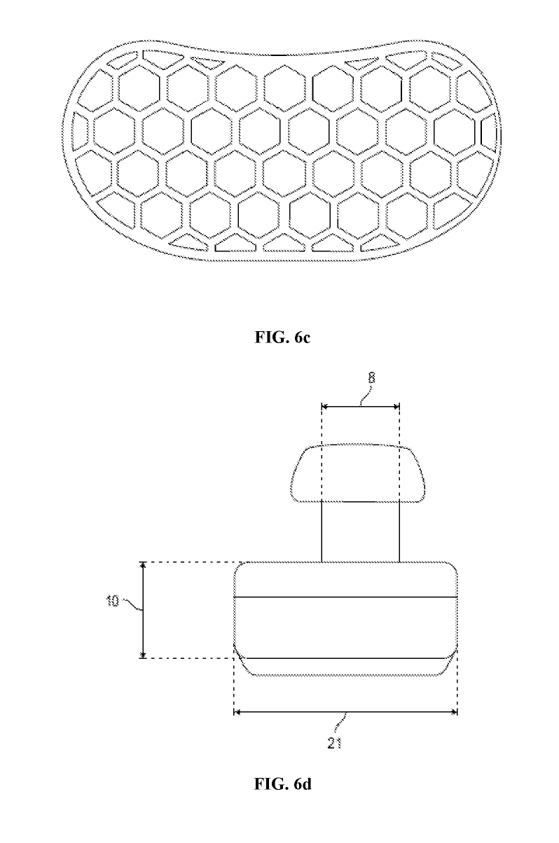

According to one embodiment herein, the filter offers high resistance to an air flow during inhaling and exhaling, wherein the calculation of the pressure is done as per formulae—P=F/A; P is the air pressure, F is the user's breathing force and A is the Area needed for breathing. The filters used in the conventional masks usually have low R (resistance) so the user can breathe without any difficulty, but low R means low filtration. Hence in the present air filter mask, the area of the filter is increased to provide higher resistance to the air and also reduces an inhaled air pressure. The dimensions of the filter unit are 45 mm in length, 21 mm in breadth and 10 mm in height while the diameter of the nostril cap is 8 mm (as shown in FIG. 6a-6d).

According to one embodiment herein, a movement of an air pipe of a left nostril is independent of a movement of the air pipe of a right nostril to provide a movement in a same as well as different directions.

According to one embodiment herein, the filter is chosen from an air filter as well as anti-bacterial filter.

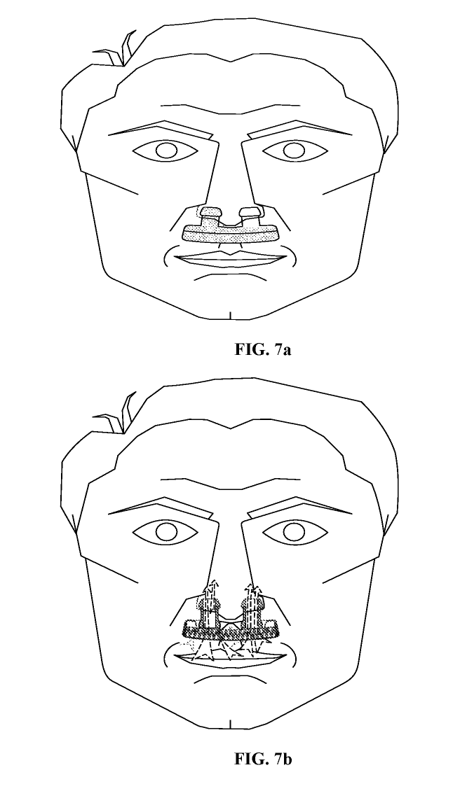

As shown in FIG. 7a-7b, the air filter mask allows a user to be wore for a long period and during various activities also. The mask is compact in nature and moves in various directions, hence do not produce hindrance during activities. During exhaling, the nostril cap holds the mask in position. Also, due to removeable filter, the user is facilitated to use same mask for various situations.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A compact air filter mask with adjustable size comprising:
a nostril unit, wherein the nostril unit comprises a nostril cap and an air pipe wherein the nostril unit holds the air filter mask tightly inside a nostril of a wearer; and
a filter unit, wherein the filter unit comprises an upper cap, a filter and a lower base, wherein the nostril unit is fixed removably in the filter unit.

2. The mask according to claim 1, wherein the nostril cap is fitted in the air pipe through a plug-in locking mechanism.

3. The mask according to claim 1, wherein the nostril cap is made up of an elastomeric material.

4. The mask according to claim 1, wherein the filter is fitted in a housing formed by plugging the upper cap in the lower base, wherein a lower part of the air pipe is fitted removably in the nostril cap.

5. The mask according to claim 4, wherein the lower part of the air pipe is a shape of a ball and fits into a socket of the upper cap forming a ball and socket joint, wherein the ball and socket joint allows the filter unit to move in a plurality of directions.

6. The mask according to claim 1, wherein the filter has a layer of a net and is attached to an elastomeric layer from sideways to prevent a flow of air from corners of the filter unit.

7. The mask according to claim 1, wherein the filter has an area of 210 sq. mm. to provide high resistance to an air flow during inhaling and exhaling.

8. The mask according to claim 1, wherein a movement of an air pipe of a left nostril is independent of a movement of the air pipe of a right nostril to provide a movement in a same as well as different directions.

9. The mask according to claim 1, wherein the filter is chosen from an air filter as well as anti-bacterial filter.
